(19) United States
(12) Patent Application Publication
(10) Pub. No.: US 2025/0007029 A1
(43) Pub. Date: Jan. 2, 2025

(54) SYSTEM FOR COOLING A TRACTION BATTERY IN THE EVENT OF THERMAL RUNAWAY

(71) Applicant: AMPERE S.A.S., Boulogne Billancourt (FR)

(72) Inventors: Eric CONDEMINE, Guyancourt (FR); Aurelie DEBART, Guyancourt (FR)

(73) Assignee: AMPERE S.A.S., Boulogne Billancourt (FR)

(21) Appl. No.: 18/706,101

(22) PCT Filed: Oct. 24, 2022
(86) PCT No.: PCT/EP2022/079556

§ 371 Date: Apr. 30, 2024

(30) Foreign Application Priority Data
Nov. 2, 2021 (FR) FR2111615

(51) Int. Cl. H01M 10/613; A62C 3/16; A62C 31/00; B60L 53/16; B60L 53/18; B60R 16/08; H01M 10/625; H01M 10/6567

(52) U.S. Cl. CPC H01M 10/613; A62C 3/16; A62C 31/005; B60L 53/16; B60L 53/18; B60R 16/08; H01M 10/625; H01M 10/6567; H01M 2220/20

(57) ABSTRACT

A system for cooling a traction battery of a motor vehicle has a charging port. The traction battery has at least one power connector fixed to a surface. At least one electric cable connects the charging port to the power connector. The system further includes a first plurality of cells arranged around the charging port, a conduit arranged around the electric cable and in fluidic communication with the first plurality of cells, a second plurality of cells arranged in the aforementioned surface, around the power connector, and in fluidic communication with the conduit. The first and second pluralities of cells and the conduit are intended to receive a cooling fluid in the event of thermal runaway of the traction battery.

The present invention relates to a system for cooling a traction battery in the event of thermal runaway.

The invention belongs in the field of traction batteries for plug-in hybrid or electric motor vehicles.

Current world regulations are converging toward the preservation of the safety of the occupants of a vehicle in the case of events such as the thermal runaway of a traction battery using lithium-ion technology. The goal therefore is notably to contain the fire, fire risk, or release of gas associated with thermal runaway.

In plug-in hybrid or electric motor vehicles, in order to contain such a fire, fire risk or release of gas, it is desirable to be able to “flood” with a coolant all of the battery elements inside the battery casing in order to limit the combustion of these elements and of the surroundings of the battery.

It is known practice to provide access for the nozzle of a fire hose underneath the rear seat of the vehicle.

Nevertheless, that solution has the disadvantage of needing to wait for the fire to have rendered this part of the vehicle accessible in order to be able to intervene.

Document JP-B-5849692 moreover discloses a battery-fire extinguishing device which comprises access to the battery via an orifice and a duct paralleling the vehicle electric charging network.

However, since access to this duct is situated immediately next to the charging port, this gives rise to a risk of confusion and mishandling by the user of the vehicle when connecting the charging port to the electrical power supply.

The objective of the present invention is to overcome the above-mentioned disadvantages of the prior art.

To this end, the present invention proposes a system for cooling a traction battery of a motor vehicle, this system comprising:
a charging port;
a traction battery comprising at least one power connector fixed on a surface of one of the walls thereof; and
at least one electric cable connecting the charging port to the power connector;
the system being notable in that it further comprises:
a first plurality of cellular cavities which are arranged around the charging port;
a duct arranged around the electric cable and in fluidic communication with the first plurality of cellular cavities;
a second plurality of cellular cavities which are arranged in the aforementioned surface, around the power connector and in fluidic communication with the duct;
the first and second pluralities of cellular cavities and the duct being intended to receive coolant in the event of thermal runaway of the traction battery.

Thus, the present invention allows the firefighter more rapid and more direct access for flooding the battery and containing the fire, while at the same time creating no risk of confusion or of mishandling on the part of the user of the vehicle when connecting the vehicle to the electrical power supply for recharging the traction battery.

In one particular embodiment, the first and second pluralities of cellular cavities are closed by precut membranes.

That allows the cellular cavities to remain closed as long as no intervention is required and to yield under the pressure of the jet of coolant at the time of intervention.

In one particular embodiment, the cellular cavities of the first plurality of cellular cavities are made of aluminum and the cellular cavities of the second plurality of cellular cavities are made of steel.

These materials are suited to the temperature values liable to be experienced respectively at the charging port and at the battery in the event of thermal runaway of the latter.

In one particular embodiment, the first plurality of cellular cavities is formed in a ring surrounding the charging port.

In the event of intervention, that allows the coolant to flow all around the charging port and over the entirety of the internal wall of the above-mentioned duct.

In one particular embodiment, the first plurality of cellular cavities is uniformly distributed in the ring.

That further improves the distribution of the coolant.

In one particular embodiment, the first and second pluralities of cellular cavities have a circular cross section.

This shape is easy to manufacture and also allows good distribution of the coolant.

For the same purpose as that indicated above, the present invention also proposes a plug-in hybrid or electric motor vehicle, notable in that it comprises a cooling system as described briefly hereinabove.

Since the advantages and particular features of the vehicle are identical to those of the cooling system, they are not repeated here.

### BRIEF DESCRIPTION OF THE DRAWINGS

Other aspects and advantages of the invention will become apparent from reading the following detailed description of particular embodiments, which are given by way of entirely nonlimiting examples, with reference to the attached drawings, in which:

FIG. 1 is a schematic depiction of part of a motor vehicle equipped with a cooling system according to the present invention, in one particular embodiment;

FIG. 2 is a schematic view, in cross section, of a charging port equipped with a cooling system according to the present invention, in one particular embodiment;

FIG. 3 is a schematic depiction of a traction battery equipped with a cooling system according to the present invention, in one particular embodiment.

### DESCRIPTION OF EMBODIMENT(S)

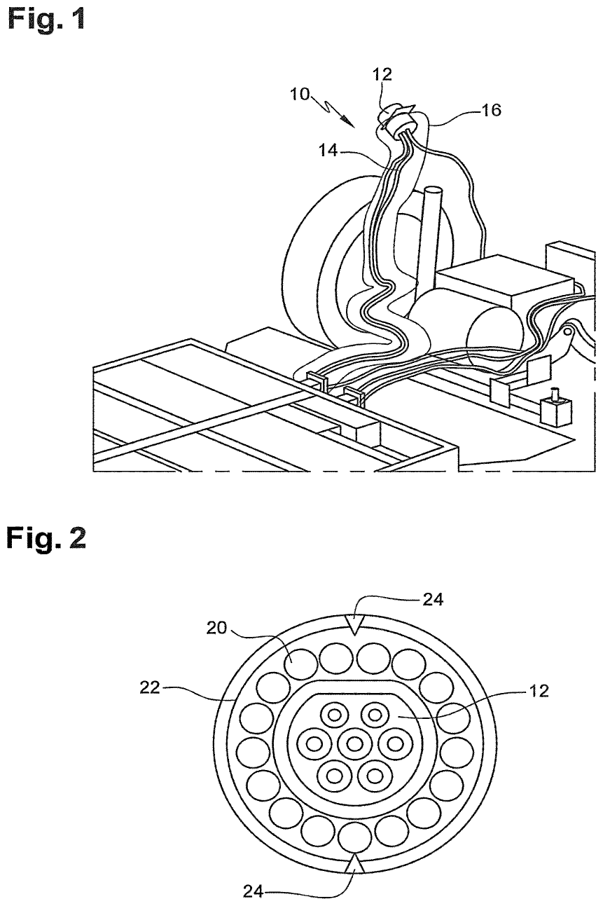

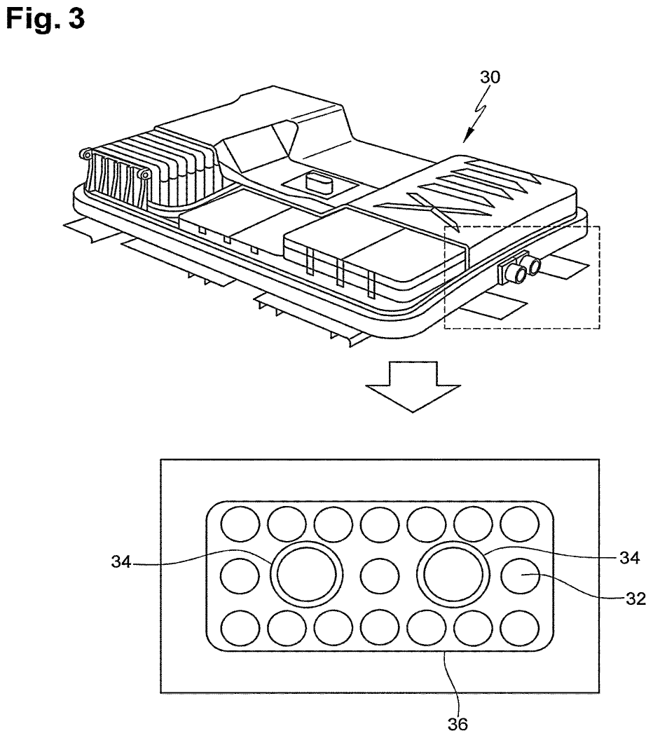

As shown by FIGS. 1 and 3, in one particular embodiment, a cooling system for cooling a traction battery 30 of a motor vehicle 10 according to the present invention comprises a charging port 12 intended to be connected to an electrical power supply in order to recharge the traction battery of the vehicle 10.

The cooling system also comprises the traction battery 30. This traction battery 30 comprises one or more power connectors 34 fixed on a surface 36 of a wall of the traction battery 30. In the particular embodiment illustrated, two power connectors 34 are fixed to the surface 36.

The system further comprises one or more electric cables 14 which connect the charging port 12 to the power connector(s) 34.

As shown by FIG. 2, according to the present invention, the system further comprises a first plurality of cellular cavities 20 which are arranged around the charging port 12. By way of nonlimiting example, in the particular embodiment illustrated, the first plurality of cellular cavities 20 comprises seventeen cellular cavities of circular cross section all having the same dimensions. In a variant, the cellular cavities could all have some other shape and do not necessarily all have the same dimensions or the same shape.

By way of nonlimiting example, the first plurality of cellular cavities 20 may be formed in a ring 22 surrounding the charging port 12. The diameter of the ring 22 is advantageously identical to the diameter of a standard fire hose nozzle. The cellular cavities 20 are advantageously, although not necessarily, uniformly distributed around the periphery of the ring 22. The ring 22 may be made from a plastics material that is resistant to fire and resistant to the high temperatures encountered in the event of thermal runaway.

Optionally, the charging port 12 may be equipped with one or more studs 24 for securing a fire hose nozzle directly to the charging port 12. This allows the firefighters to attach the fire hose nozzle directly to the vehicle in cases of severe heat and when it is difficult and too risky to remain close to the vehicle in order to contain the fire. In the particular embodiment illustrated in FIG. 2, two diametrically opposed studs 24 are provided. As a variant, the securing stud(s) 24 may be replaced by any other device that allows the fire hose nozzle to be clip-fastened onto the charging port 12.

As shown in FIG. 1, according to the present invention, the system also comprises a duct 16 (visible in FIG. 1) arranged around the electric cable(s) 14. The duct 16 is in fluidic communication with the first plurality of cellular cavities 20. By way of nonlimiting example, the duct 16 may be made from braided fiberglass, or else from a material similar to that of a fire hose nozzle, for example a circular textile with a diagonal weave of high tenacity polyester threads.

As shown by FIG. 3, according to the present invention, the system further comprises a second plurality of cellular cavities 32 which are arranged in a surface 36 of a wall of the battery, around the power connector(s) 34. The surface 36 may be a plate welded to the battery pack or may be part of the wall of the battery pack. The second plurality of cellular cavities 32 is in fluidic communication with the duct 16. By way of entirely nonlimiting example, in the particular embodiment illustrated in FIG. 3, the second plurality of cellular cavities 32 comprises seventeen cellular cavities of circular cross section all having the same dimensions.

The first and second pluralities of cellular cavities 20, 32 and the duct 16 are intended to receive a coolant, such as water, in the event of thermal runaway of the traction battery 30. Thus, the duct 16 will convey the coolant from the charging port 12 to inside the traction battery 30.

The duct 16 may be made from a rigid or a flexible material. In the case of flexible material, it will nevertheless need to be able to withstand high pressures as it is being filled with coolant. The material chosen will also need to be fire-resistant and resistant to the high temperatures encountered in the event of thermal runaway of the traction battery 30.

The cellular cavities of the first and second pluralities of cellular cavities 20, 32 are, for example, closed by membranes that are precut so as to yield under the pressure of the jet of coolant. By way of indication, the pressure of the water ejected by a fire hose nozzle may be as much as 300 bar.

By way of nonlimiting example, the membranes of the first plurality of cellular cavities 20 may be made of aluminum or of plastic, while the membranes of the second plurality of cellular cavities 32 may be made of sheet steel, so that they are better able to resist heat than the membranes of the first plurality of cellular cavities 20.

The pre-cutting of the membranes consists in creating an imprint of each cellular cavity, so as to introduce mechanical weakness that will allow the membrane to yield under the pressure of the jet of coolant. By way of nonlimiting example, this imprint may be achieved by laser cutting or waterjet cutting or else using a pre-cutting press.

By way of nonlimiting example, although not necessarily, as described hereinabove, the cellular cavities of the first and second pluralities of cellular cavities 20, 32 may have a circular cross section, as in the particular embodiment illustrated in FIGS. 2 and 3.

1-7. (canceled)

8. A system for cooling a traction battery of a motor vehicle, said system comprising:
a charging port;
a traction battery comprising at least one power connector fixed on a surface of a wall of the battery;
at least one electric cable connecting said charging port to said power connector;
a first plurality of cellular cavities which are arranged around said charging port;
a duct arranged around said electric cable and in fluidic communication with said first plurality of cellular cavities; and
a second plurality of cellular cavities which are arranged in said surface, around said power connector and in fluidic communication with said duct;
said first and second pluralities of cellular cavities and said duct being configured to receive coolant in the event of thermal runaway of said traction battery.

9. The system as claimed in claim 8, wherein said first and second pluralities of cellular cavities are closed by pre-cut membranes.

10. The system as claimed in claim 8, wherein the membranes of said first plurality of cellular cavities are made of aluminum and the membranes of said second plurality of cellular cavities are made of steel.

11. The system as claimed in claim 8, wherein said first plurality of cellular cavities is formed in a ring surrounding said charging port.

12. The system as claimed in claim 11, wherein said first plurality of cellular cavities is uniformly distributed in said ring.

13. The system as claimed in claim 8, wherein said first and second pluralities of cellular cavities are of circular cross section.

14. A plug-in hybrid or electric motor vehicle, comprising:
the system as claimed in claim 8.
